(19) United States
(12) Patent Application Publication
(10) Pub. No.: US 2012/0067232 A1
(43) Pub. Date: Mar. 22, 2012

(54) OFFSET PRINTING APPARATUS

(76) Inventors: Hiroshi Saito, Yokohama-shi (JP); Hiroaki Imaizumi, Kawasaki-shi (JP)

(21) Appl. No.: 13/375,032

(22) PCT Filed: Jun. 4, 2010
(86) PCT No.: PCT/JP2010/003755

§ 371 Date: Nov. 29, 2011

(30) Foreign Application Priority Data
Jun. 5, 2009 (JP) P2009-136245

(51) Int. Cl. B41F 7/02

(52) U.S. Cl. 101/217

(57) ABSTRACT

On a guide rail (2) provided on a mount (1), there are travelably provided a plate table (3) and a substrate table (4). On the tables (3, 4), there are respectively installed alignment stages (6, 8), on which a plate (7) and a substrate (9) are respectively held. At required locations on the mount (1), there are provided separate alignment areas (15, 16) respectively for the plate (7) and the substrate (9). In the alignment areas (15, 16), the position of the plate (7) held on the plate table (3) and the position of the substrate (9) held on the substrate table (4) are subjected to an initial alignment, to thereby correct the positions so that the plate (7) and the substrate (9) squarely face the center of axle of a blanket roller (11) in the same relative arrangement with respect. As a result, reproducibility of the printing pattern that is printed from the plate (7) onto the substrate (9) via the blanket roller (11) is improved.

### TECHNICAL FIELD

The present invention relates to an offset printing apparatus used for performing fine printing on a printing target with a high printing accuracy, such as in the case where an electrode pattern is formed on a substrate by printing.

Priority is claimed on Japanese Patent Application No. 2009-136245, filed on Jun. 5, 2009, the contents of which are incorporated herein by reference.

### BACKGROUND ART

As one of the printing techniques, there is known an offset printing technique. In this type of technique, offset printing using an intaglio plate is known as a technique in which ink is transferred (received) from an inked intaglio plate to a rolling blanket roller and then the ink is retransferred (printed) from the blanket roller to the printing target, to thereby make it possible to print a printing pattern from the intaglio plate onto the surface of the printing target with good reproducibility.

In recent years, as a technique of forming an electrode pattern (a conductive pattern) such as for liquid crystal displays on a required substrate, there are proposed printing techniques of using a conductive paste as a printing ink instead of fine machining of a metal vapor-deposited film by etching or the like, for example, techniques of printing and forming an electrode pattern of a substrate by use of an intaglio offset printing technique (for example, refer to Patent Document 1 and Patent Document 2).

In the case of offset-printing a fine printing pattern such as an electrode pattern onto a flat printing target, high printing accuracy is required. Therefore, as an offset printing apparatus for performing offset printing with high printing accuracy, it is considered to be advantageous to use a surface printing apparatus with a flat plate which is similar in shape to the printing target.

The following technique has been conventionally proposed to improve printing accuracy. In this technique, on a movement table (stage) capable of traveling below a blanket roller, there are provided: a surface plate for a plate on which a printing plate is mounted and fixed; and a surface plate for a substrate on which a glass substrate as a printing target is mounted and fixed. These two plates are spaced a required distance from each other along the direction in which the table travels. Furthermore, either one of the surface plate for a plate and the surface plate for a substrate is provided with a drive mechanism that displaces its corresponding surface plate in an optional direction along its upper surface. Furthermore, a camera for picking up an image of a reference portion the printing plate fixed on the surface plate for a plate, and a camera for picking up an image of a reference portion of the glass substrate fixed on the surface plate for a substrate are prepared. The pieces of image information on the printing plate and the glass substrate that have been picked up by the camera for a plate and the camera for a substrate are compared with each other. The drive mechanism provided to one of the surface plates is used to make an adjustment to the position of its corresponding surface plate so as to minimize the relative displacement between the two. According to the technique, it is considered that the relative positional displacement between the printing plate and the glass substrate can be corrected with high accuracy, and that highly accurate printing can be performed onto the glass substrate (for example, refer to Patent Document 3).

### CITATION LIST

Patent Document 1: Japanese Patent No. 2797567
Patent Document 2: Japanese Patent No. 3904433
Patent Document 3: Japanese Patent No. 3112581

However, in the technique shown in Patent Document 3, only either one of the surface plate for a plate and the surface plate for a substrate is provided with a drive mechanism for displacing its corresponding surface plate. Therefore, even if it is possible to correct a relative positional displacement between the printing plate and the glass substrate with high accuracy, it is difficult to bring the plate and a printing target such as the glass substrate into contact with the blanket roller in an optimum condition.

That is, in the case of forming an electrode pattern such as for a liquid crystal display by offset printing, a fine electrode width of, for example, approximately 10 μm is required. To perform printing with such high accuracy, it is considered that the tolerance of an attachment position of a printing target is several μm.

On the other hand, in the case of a printing operation with a printing target being sequentially replaced with new ones, it is difficult to keep the tolerances of the attachment positions within a range of several μm for all the printing targets.

In addition, plates gradually wear out (are consumed) as a result of their use in printing. This leads to a requirement that the plates be replaced every required number of times of printing or every required period of printing time. Furthermore, there are cases where it is necessary for plates to be replaced when overprinting is performed. When such plate replacement is performed, it is difficult to keep the positional displacement between the attachment position of a plate after the replacement and the attachment position of a plate before the replacement within a range of several μm every time.

Therefore, when printing operation is performed with printing targets being sequentially replaced with new ones, there is a possibility of an occurrence of a positional displacement of an attachment position for every printing target. In addition, there is also a possibility of an occurrence of a positional displacement of the attachment position of a plate for every replacement of plates.

However, the technique shown in Patent Document 3 is a technique in which the position of either one of a plate and a glass substrate is taken as a reference and the position of the other one is corrected so as to match the reference. Therefore, if the attachment position of the plate as a reference or the glass substrate as a printing target is inclined away from the direction orthogonal to the center of an axle of the blanket roller, there arises a problem in that both of the plate and the glass substrate as a printing target are brought into contact with the rolling outer circumference of the blanket roller in a diagonally inclined manner.

Furthermore, only one of the surface plate for a plate and the surface plate for a substrate is provided with a drive mechanism. Consequently, Patent Document 3 has no idea of making positional corrections of both the plate and the glass substrates as a printing target while either one is in contact with the blanket roller, to thereby improve printing accuracy.

Therefore, the present invention has an object to provide an offset printing apparatus capable of: positioning both of a plate held on a plate table and a printing target held on a printing target table with high accuracy, and also bringing the plate held on the plate table and the printing target held on the printing target table into contact with a blanket roller in a state of squarely facing the blanket roller, to thereby improve the reproducibility of a printing position; and improving printing accuracy further by making positional corrections of the plate and the printing target while either one is in contact with the blanket roller.

### DISCLOSURE OF INVENTION

To solve the above problems, a first offset printing apparatus according to the present invention includes a plate table and a printing target table separately or integrally traveling on a guide rail provided on a mount, and brings from above a blanket roller into contact with a plate held on the plate table and a printing target held on the printing target table in a sequential manner, to thereby perform a transfer from the plate to the blanket roller and a retransfer from the blanket roller to the printing target. Furthermore, the plate is held on an alignment stage provided on a top portion of the plate table; the printing target is held on an alignment stage provided on a top portion of the printing target table; and there are respectively provided at required locations on the mount an alignment area for aligning the plate held on the alignment stage on the plate table and an alignment area for aligning the printing target held on the alignment stage on the printing target table.

In the above structure, instead of the alignment areas, there may be provided at a required location on the mount a common alignment area for aligning the plate held on the alignment stage on the plate table and aligning the printing target held on the alignment stage on the printing target table, and wherein the alignment area includes a common alignment sensor for detecting the plate held on the alignment stage on the plate table and the printing target held on the alignment stage on the printing target table.

In the above structures, it may be possible to align the plate and the printing target even if the blanket roller is in contact with the plate or the printing target held respectively on the alignment stage on the plate table or on the alignment stage on the printing target table.

According to the offset printing apparatus of the present invention, excellent advantages as follows are exerted.

(1) With an initial alignment of the plate being performed by the alignment stage on the plate table, it is possible to hold the plate at a predetermined position of the plate table without being influenced by an error in attachment position of the plate to the plate table. Similarly, with an initial alignment of the printing target being performed by the alignment stage on the printing target table, it is possible to hold the printing target at a predetermined position of the printing target table without being influenced by an error in attachment position of the printing target to the printing target table. Therefore, the relative position between the plate held on the plate table and the printing target held on the printing target table when they pass through under the blanket roller along the same guide rail can be made the same every time. Hence, it is possible to print the printing pattern of the plate onto the printing target with highly accurate positional reproducibility.

(2) Consequently, it is possible to perform printing high in reproducibility of the printing position and in reproducibility of the printing pattern onto printing targets, enabling printing of a fine printing pattern such as an electrode pattern onto the printing targets with accuracy and with high reproducibility. Furthermore, even in the case where a fine printing pattern such as an electrode pattern is overprinted onto a printing target while plates are being replaced, it is possible to suppress displacement of overlapping.

(3) With a structure where there is provided at a required location on the mount a common alignment area for aligning the plate held on the alignment stage on the plate table and aligning the printing target held on the alignment stage on the printing target table, and where the alignment area includes a common alignment sensor for detecting the plate held on the alignment stage on the plate table and the printing target held on the alignment stage on the printing target table, it is possible to exclude an error due to an individual difference among the alignment sensors provided on alignment areas or due to other reasons, and to make the same relative arrangement between the plate held on the plate table and the printing target held on the printing target table every time. Therefore, it is possible to perform more highly accurate printing.

(4) With a structure where it is possible to align the plate and the printing target even if the blanket roller is in contact with the plate or the printing target held respectively on the alignment stage on the plate table or the alignment stage on the printing target table, it is possible to correct the position of the plate or the printing target so as to bring the plate and the printing target into contact with the blanket roller in a state of squarely facing the blanket roller without producing a lateral displacement, even though the degree of straightness of the guide rail and the degree of orthogonality of the guide rail with respect to the center of axle of the blanket roller are decreased directly below the blanket roller. In addition, in the case where the peripheral speed of the blanket roller is changed even if the blanket roller is rotated at a constant speed because the blanket roller is off-centered, it is possible to correct the movement speeds of the plate and the substrate in synchronicity with the change in the peripheral speed.

(5) Furthermore, when a transfer or a retransfer is performed by pressing the blanket roller with a required contact pressure against the plate held on the plate table or the printing target held on the printing target table, and even if a minute positional displacement is produced in the plate or the printing target due to an influence of the contact pressure acting from the blanket roller or other reasons, it is possible to correct the positional displacement.

### BRIEF DESCRIPTION OF THE DRAWINGS

FIG. 1 is a schematic side view showing one embodiment of an offset printing apparatus of the present invention.

FIG. 2 is a schematic perspective view showing a portion of an alignment area for a plate of the offset printing apparatus of FIG. 1.

FIG. 3 is a schematic perspective view showing a portion of an alignment area for a substrate of the offset printing apparatus of FIG. 1.

FIG. 4 is a schematic side view showing another embodiment of an offset printing apparatus of the present invention.

### BEST MODE FOR CARRYING OUT THE INVENTION

Hereunder is a description of embodiments for carrying out the present invention with reference to the drawings.

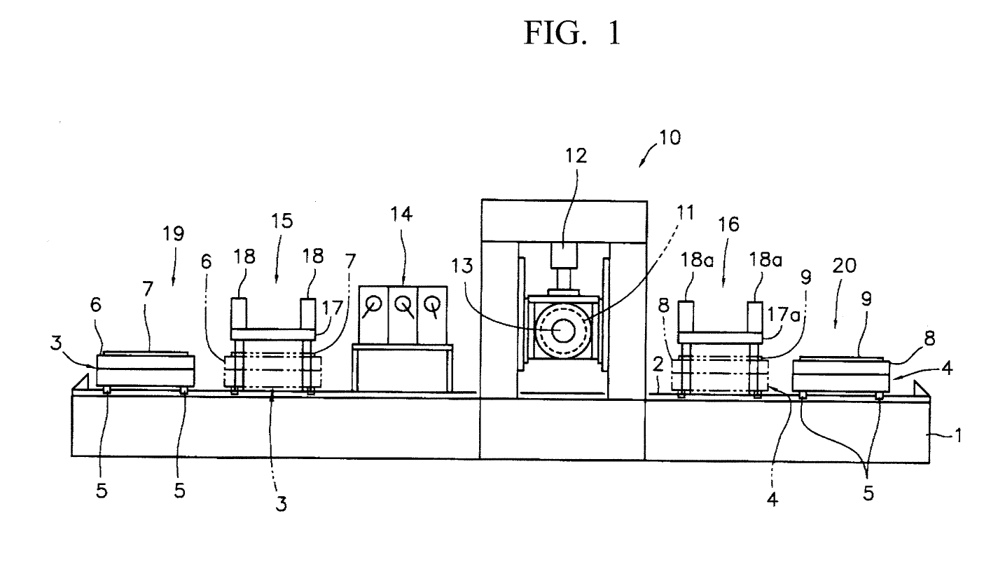

FIG. 1 to FIG. 4 show one embodiment of an offset printing apparatus of the present invention. It has a structure as follows:

On a top side of a horizontal mount 1, there are provided guide rail(s) 2, for example a pair of guide rails 2, extending in one direction (the X axis direction). On the guide rails 2, a plate table 3 and a substrate table 4 as a printing target table are arranged in this order from one end side in the longitudinal direction of the guide rails 2 (from the left side in FIG. 1). In addition, the tables 3, 4 are slidably attached to each of the guide rails 2 via a set of guide blocks 5.

The tables 3, 4 each include a drive apparatus (not shown in the figures) such as a linear motor, and hence are capable of independently reciprocating (traveling) along the guide rails 2. Furthermore, with a linear scale (not shown in the figures) provided at a required location on the mount 1 along the guide rails 2, it is possible to detect the positions of the plate table 3 and the substrate table 4 along the longitudinal direction of the guide rails 2, that is, their absolute positions (coordinates) relative to a required point in the X axis direction.

Furthermore, on the top portion of the plate table 3, there is provided an alignment stage 6 capable of horizontally moving in the longitudinal direction of the guide rails 2 (in the X axis direction) and in the direction orthogonal to the longitudinal direction of the guide rails 2 (in the Y axis direction), and capable of rotating through the yaw angle (θ) with respect to the longitudinal direction of the guide rails 2. It is possible to mount and hold a plate 7 on the topside of the alignment stage 6.

On the top portion of the substrate table 4, there is provided an alignment stage 8 capable of horizontally moving in the X axis direction and the Y axis direction, and capable of rotating through the yaw angle (θ), similarly to the alignment stage 6 on the plate table 3. It is possible to mount and hold a substrate 9 as a printing target on the top side of the alignment stage 8.

On a part on the mount 1 corresponding to the middle portions in the longitudinal direction of the guide rails 2, at a position a required distance above the guide rails 2, there is provided a transfer mechanism portion 10. The transfer mechanism portion 10 includes: a blanket roller 11 arranged along a direction orthogonal to the longitudinal direction of the guide rails 2 (along the Y axis direction); a raising-lowering actuator 12 for raising and lowering the blanket roller 11; and a drive motor 13 for rotationally driving the blanket roller 11.

Furthermore, at a required location on the mount 1 on which the plate table 3 is capable of traveling, for example, at a position a required distance closer to first ends in the longitudinal direction of the guide rails 2 than the transfer mechanism portion 10, there is provided an inking apparatus 14 for inking the plate 7 held on the plate table 3. In addition, at another required location on the mount 1 on which the plate table 3 is capable of traveling, for example, at a position closer to the first ends in the longitudinal direction of the guide rails 2 than the inking apparatus 14, there is provided an alignment area 15 for aligning the plate 7 held on the alignment stage 6 on the plate table 3.

Furthermore, at a required position on the mount 1 on which the substrate table 4 is capable of traveling, for example, at a position a required distance closer to second ends of the guide rails 2 than the transfer mechanism portion 10, there is provided an alignment area 16 for aligning the substrate 9 held on the alignment stage 8 on the substrate table 4. Thus, these members substantially constitute the offset printing apparatus of the present invention.

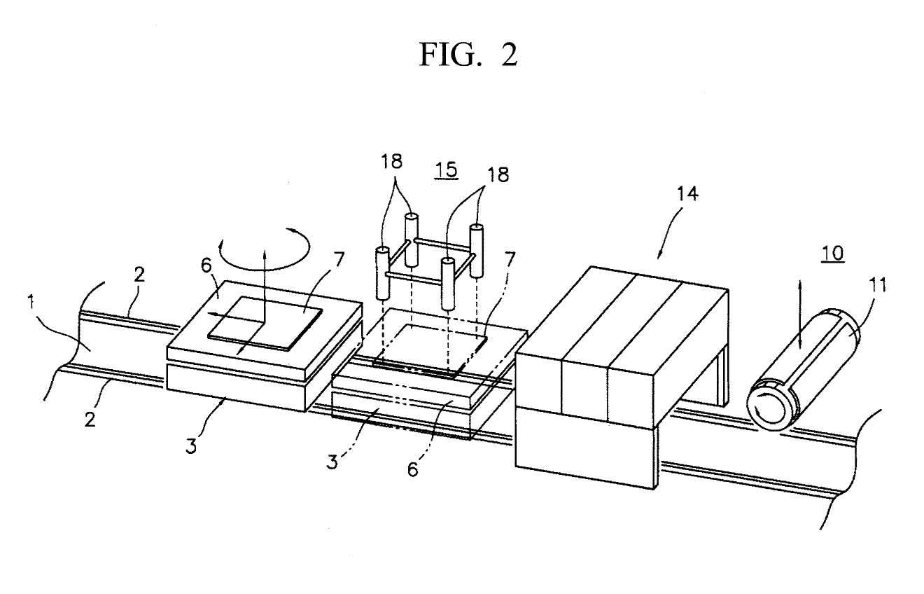

To be more specific, as shown in FIG. 1 and FIG. 2, the alignment area 15 for a plate has a support mount 17 under which the plate table 3 traveling along the guide rails 2 can pass through. Furthermore, the support mount 17 has precision cameras 18 as alignment sensors provided downwardly at two locations corresponding to a pair of diagonally opposing corners of the plate 7 held on the alignment stage 6 on the plate table 3 or at four locations corresponding to the four corner locations of the plate 7. FIG. 2 shows a structure in which the precision cameras 18 are provided at four locations corresponding to the four corners of the plate 7.

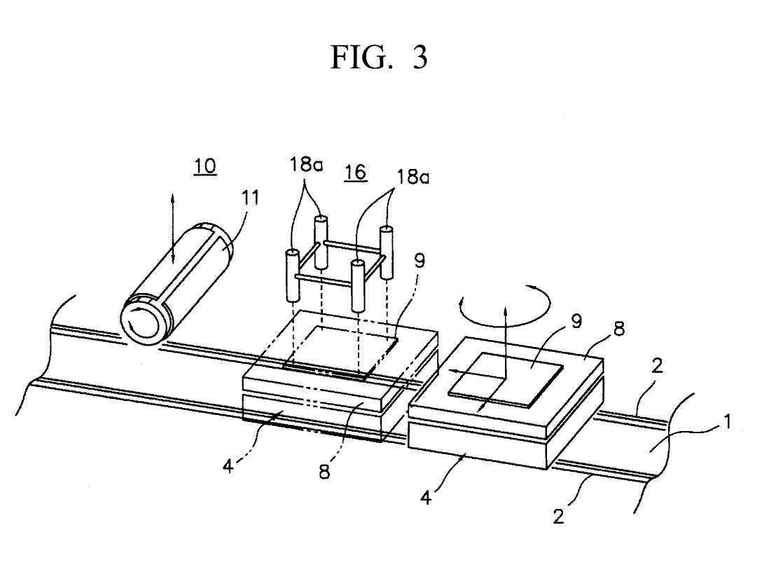

The alignment area 16 for a substrate has, similarly to the alignment area 15 for a plate, a support mount 17a under which the substrate table 4 traveling along the guide rails 2 can pass through, as shown in FIG. 1 and FIG. 3. Furthermore, the support mount 17a has precision cameras 18a as alignment sensors provided downwardly at two locations corresponding to a pair of opposing corners of the substrate 9 held on the alignment stage 8 on the substrate table 4 or at four locations corresponding to the four corner locations of the substrate 9. FIG. 3 shows a structure in which the precision cameras 18a are provided at four locations corresponding to the four corners of the plate 7.

Furthermore, due to the necessity of performing offset printing, the offset printing apparatus of the present invention includes a plate table waiting area 19 at a position on the mount 1 corresponding to the first end portions in the longitudinal direction of the guide rails 2, as shown in FIG. 1. With the plate table waiting area 19, it is possible to move the plate table 3 to the first ends of the guide rails 2 in the longitudinal direction and keep it waiting there, and also to replace the plate 7 held on the alignment stage 6 on the plate table 3. The offset printing apparatus of the present invention further includes a substrate installation area 20 at a position on the mount 1 corresponding to the second end portions in the longitudinal direction of the guide rails 2. The substrate installation area 20 is an area for attaching a new substrate 9 to the alignment stage 8 on the substrate table 4 and removing a substrate 9 after printing operation in a state with the substrate table 4 being moved to and kept waiting at the second end portions in the longitudinal direction of the guide rails 2.

When the offset printing apparatus of the present invention with the above structure is used, the following operation is carried out.

When a new plate 7 is held on the alignment stage 6 on the plate table 3 for starting a printing job, and when a new plate 7 is held on the alignment stage 6 for replacement with a plate 7, the plate table 3 is traveled to the alignment area 15 along the guide rails 2 and is then stopped at a predetermined alignment position (not shown in the figures) in the alignment area 15.

In this state, pointing markers (not shown in the figures) provided at the two diagonally opposing corners or four corner portions of the plate 7 held on the alignment stage 6 on the plate table 3 are shot with the corresponding precision cameras 18. Based on the image information, the alignment stage 6 is moved horizontally within the X-Y plane and also rotationally moved through the yaw angle (θ) so that the positional arrangement of the pointing markers of the plate 7 that has been shot matches a predetermined arrangement, to thereby make a positional correction of the plate 7. As a result, irrespective of the attachment accuracy of the plate 7 with respect to the alignment stage 6 on the plate table 3, an initial alignment is performed so as to make the relative arrangement of the plate 7 to the plate table 3 always fixed. As for the alignment of the plate 7, the same plate 7 may be aligned regularly for every required number of times of printing or every required length of time used for printing.

On the other hand, when a new substrate 9 as a printing target is held on the alignment stage 8 on the substrate table 4, the substrate table 4 is transported to the alignment area 16 along the guide rails 2 and is then stopped at a predetermined alignment position (not shown in the figures) in the alignment area 16.

In this state, pointing markers (not shown in the figures) provided at the two diagonally opposing corners or four corner portions of the substrate 9 held on the alignment stage 8 on the substrate table 4 are shot with the corresponding precision cameras 18a. Based on the image information, the alignment stage 8 is moved horizontally within the X-Y plane and also rotationally moved through the yaw angle (θ) so that the positional arrangement of the pointing markers of the substrate 9 that has been shot matches a predetermined arrangement, to thereby make a positional correction of the substrate 9. As a result, irrespective of the attachment accuracy of substrates 9 with respect to the alignment stage 8 on the substrate table 4, an initial alignment is performed so as to make the relative arrangement of the substrates 9 to the substrate table 4 fixed every time.

With the above operation, when the plate table 3 and the substrate table 4 traveling along the same guide rails 2 are placed at the same location of the guide rails 2, for example, at a position directly below the blanket roller 11 of the transfer mechanism portion 10, then the relative relationship between the position of the plate 7 held on the plate table 3 that is located at the position directly below the blanket roller 11 and the position of the substrate 9 held on the substrate table 4 that is located at a position directly below the blanket roller 11 is the same every time. Furthermore, it is possible to arrange the plate 7 held on the plate table 3 and the substrate 9 held on the substrate table 4 in a manner squarely facing the center of axle of the blanket roller 11.

After that, the plate table 3 is moved to the inking apparatus 14, and inking is performed on the plate 7 held on the plate table 3. Subsequently, the plate table 3 is moved to the transfer mechanism portion 10. Then, while the plate table 3 is being traveled, the blanket roller 11, at a peripheral speed in synchronicity with the speed of the plate table 3, is brought from above into contact with the plate 7 held on the plate table 3 to transfer ink from the plate 7 to the blanket roller 11. Subsequently, the substrate table 4 is moved to the transfer mechanism portion 10. Then, while the substrate table 4 is being traveled in the same direction as and in the similar condition to when the plate table 3 is moved to the transfer mechanism portion 10, the blanket roller 11 at a peripheral speed in synchronicity with the speed of the substrate table 4 is brought from above into contact with the substrate 9 held on the substrate table 4 to perform a retransfer from the blanket roller 11 to the substrate 9, to thereby print a printing pattern of the plate 11 onto the substrate 9. Thus, offset printing is performed.

After this, every time the substrate 9 held on the substrate table 4 is replaced with a new substrate 9, the aforementioned initial alignment is performed. As a result, the relative relationship between the position of the plate 7 held on the plate table 3 that is located at a position directly below the blanket roller 11 and the position of the substrate 9 newly held on the substrate table 4 that is located at a position directly below the blanket roller 11 is the same every time. Therefore, the printing pattern of the plate 7 is printed onto substrates 9 as printing targets with highly accurate positional reproducibility.

Furthermore, if, directly below the blanket roller 11, the guide rails 2 are inclined or curved away from the direction orthogonal to the center of axle of the blanket roller 11 due to manufacturing accuracy or the like, then the plate table 3 and the substrate table 4 traveling along the guide rails 2 pass under the blanket roller 11 in a direction inclined away from the direction orthogonal to the center of axle of the blanket roller 11 or pass under the blanket roller 11 while making a curve. As a result, when the blanket roller 11 is brought into contact with the plate 7 on the plate table 3 or the substrate 9 on the substrate table 4 located so as to squarely face the center of axle of the blanket roller 11 at the stage of the initial alignment, the plate or the substrate 9 passes under the blanket roller 11 while moving in a direction inclined away from the direction orthogonal to the center of axle of the blanket roller 11 or making a curve. This may lead to a decrease in printing accuracy.

In this case, when the blanket roller 11 is in contact with the plate 7 on the plate table 3 or the substrate 9 on the substrate table 4 from above, the alignment stage 6 or 8 respectively on the table 3 or 4 is horizontally moved within the X-Y plane and rotationally moved so as to cancel the inclination and the curve of the table 3 or 4 in its traveling direction along the guide rails 2, to thereby move the plate 7 on the plate table 3 or the substrate 9 on the substrate table 4 in the direction orthogonal to the center of the axle of the blanket roller 11.

Furthermore, in the case where the blanket roller 11 is off-center due to manufacturing inaccuracy or the like, its peripheral speed changes. This is because, even if the blanket roller 11 is rotated at a constant speed, its apparent radius from the center of rotation to a peripheral position changes according to its rotation angle.

In this case, a correlation between the rotation angle and the change in peripheral speed is measured beforehand. Next, when the plate table 3 or the substrate table 4 passes under the blanket roller 11, the alignment stages 6, 8 respectively on the tables 3, 4 are moved along the traveling directions of the tables 3, 4 in accordance with the rotation angle of the blanket roller 11. Thus, the moving speeds of the plate 7 and the substrate 9 held respectively on the alignment stages 6, 8 are increased or decreased with respect to the moving speeds of the tables 3, 4. Thereby, the moving speeds of the plate 7 and the substrate 9 are synchronized with the changing peripheral speed of the blanket roller 11.

Thus, according to the offset printing apparatus of the present invention, with an initial alignment of the plate 7 being performed by the alignment stage 6 on the plate table 3, it is possible to hold the plate 7 at a predetermined position of the plate table 3 without being influenced by an error in attachment position of the plate 7 when the plate 7 is attached to the plate table 3. Similarly, with an initial alignment of the substrate 9 being performed by the alignment stage 8 on the substrate table 4, it is possible to hold the substrate 9 at a predetermined position of the substrate table 4 without being influenced by an error in attachment position of the substrate 9 when the substrate 9 is attached to the substrate table 4. Therefore, it is possible to make same the relative position between the plate 7 on the plate table 3 when passing under the blanket roller 11 and the substrate 9 on the substrate table 4 when passing under the blanket roller 11 every time. Consequently, it is possible to print the printing pattern of the plate 7 onto the substrates 9 as printing targets with highly accurate positional reproducibility.

Furthermore, even if the degree of straightness of the guide rails 2 that guide the travel of the plate table 3 and the substrate table 4 directly below the blanket roller 11, or the degree of orthogonality of the guide rails 2 with respect to the center of the axle of the blanket roller 11 is decreased, it is possible to bring the plate 7 and the substrate 9 into contact with the blanket roller 11 while squarely facing the blanket roller 11 without producing a lateral displacement. In addition, even if the blanket roller 11 is off-centered, it is possible to bring the plate 7 and the substrate 9 into contact with the blanket roller 11 while the moving speeds of the plate 7 and the substrate 9 are being changed in synchronicity with the change in the peripheral speed of the blanket roller 11. Consequently, it is possible to improve the reproducibility of the printing pattern.

Therefore, it is possible to perform printing high in reproducibility of a printing position and also in reproducibility of a printing pattern onto the substrates 9. Hence, it is possible to print a fine printing pattern such as an electrode pattern onto the substrate 9. Furthermore, even if a fine printing pattern such as an electrode pattern is printed onto the substrate 9 while the plates 7 are replaced, it is possible to suppress displacement of overlapping.

Furthermore, when the blanket roller 11 is pressed against the plate 7 held on the plate table 3 or the substrate 9 held on the substrate table 4 with a predetermined contact pressure, there are cases where a minute positional displacement occurs in the plate 7 or the substrate 9 due to an influence by the contact pressure acting from the blanket roller 11 or other influences. Even in such cases, the positions of the plate 7 on the plate table 3 and the substrate 9 on the substrate table 4 that are located directly below the blanket roller 11 are detected in a realtime manner by a displacement sensor (not shown in the figures). Based on the detection signals, it is possible to use the alignment stage 6 on the plate table 3 and the alignment stage 8 on the substrate table 4 to make a positional correction of the plate 7 and the substrate 9, respectively.

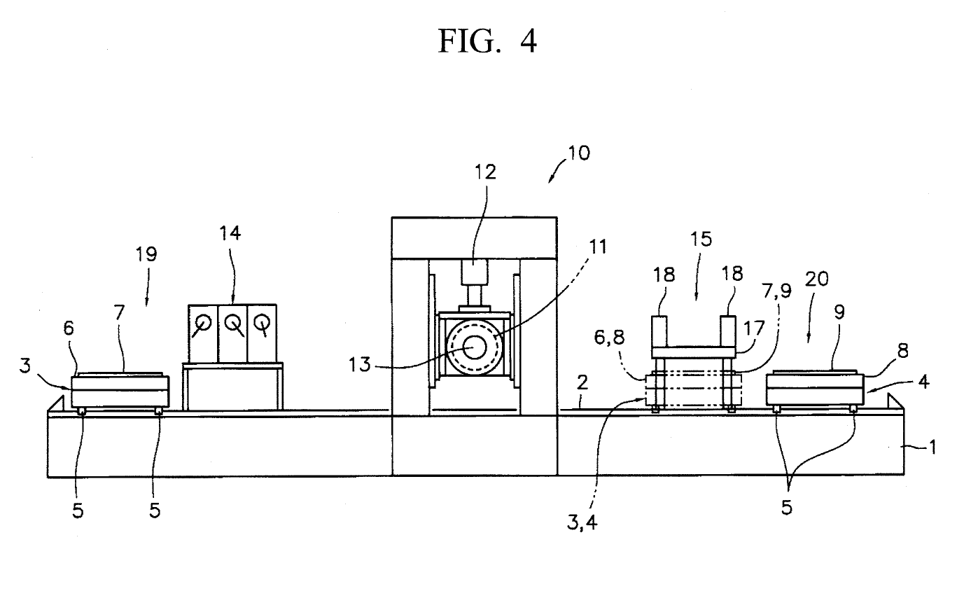

Next, FIG. 4 shows another embodiment of the present invention. This embodiment has a structure similar to that shown in FIG. 1 to FIG. 3. However, instead of the structure where the alignment areas provided separately on the mount 1 for the plate 7 held on the alignment stage 6 on the plate table 3 and the substrate 9 held on the alignment stage 8 on the substrate table 4, a common alignment area 15 for alignment of both the plate 7 and the substrate 9 is provided at a required location on the mount 1 that allows both the plate table 3 and the substrate table 4 to travel along the guide rails 2.

Note that the alignment area 15 has a structure similar to that of the alignment area 15 for the plate 7 shown in FIG. 1 and FIG. 2. Otherwise, the embodiment has a structure similar to that shown in FIG. 1 to FIG. 3. Constituent elements the same as those shown in FIG. 1 to FIG. 3 are denoted by the same reference symbols.

In the case where the offset printing apparatus of the present embodiment is used, the plate 7 held on the plate table 3 and the substrate 9 held on the substrate table 4 are sequentially subjected to the initial alignment in the common alignment area 15. Other than this, offset printing is performed in a procedure similar to that of the embodiment of FIG. 1 to FIG. 3.

In this manner, according to the offset printing apparatus of the present embodiment, it is possible to obtain advantages similar to those of the embodiment of FIG. 1 to FIG. 3. Furthermore, it is possible to subject the plate 7 held on the plate table 3 and the substrate 9 held on the substrate table 4 to an initial alignment in the same alignment area 15 by use of precision cameras 18 as the same alignment sensors. Therefore, with an error due to an individual difference among the precision cameras 18 or other reasons being excluded, it is possible to make the same the relative arrangement between the plate 7 held on the plate table 3 and the substrate 9 held on the substrate table 4 accurately every time.

As a result, it is possible to expect the advantage of further improving the reproducibility when the printing pattern of the plate 7 is offset-printed onto the substrate 9.

Note that the present invention is not limited to only the aforementioned embodiments. For example, it is desirable that the alignment stage 6 on the plate table 3 and the alignment stage 8 of the substrate table 4 be provided with three degrees of freedom with which they are capable of horizontally moving in the X axis and Y axis directions and rotationally moving through the yaw angle (θ). However, alignment stages with two degrees of freedom only of a horizontal movement in the Y axis direction; and a rotational movement through the yaw angle (θ) may be used. In this case, positional corrections of the plate 7 and the substrate 9 along the X axis direction are carried out by correcting the positions of the corresponding tables 3, 4 in the X axis direction.

The alignment stages 6, 8 may have the size in the up-down direction or the shape of their flat surface appropriately modified. Moreover, as the alignment stages 6, 8, alignment stages provided with an optional operation mechanism may be used.

As for the arrangement of the alignment areas 15, 16 on the mount 1 in the embodiment of FIG. 1 to FIG. 3, and the arrangement of the alignment area 15 on the mount 1 in the embodiment of FIG. 4, the arrangement in the longitudinal direction of the guide rails 2 may be approximately modified so long as the areas are within the range that allows the plate table 3 and the substrate table 4 to travel, and also they do not interfere with the transfer mechanism portion 10 and the inking apparatus 14, and the plate table waiting area 19 and the substrate installation area 20.

As the alignment sensors for the alignment areas 15, 15a, optional alignment sensors other than the precision cameras 18, 18a may be used so long as they are capable of highly accurately detecting the positions of the pointing markers provided on the plate 7 held on the alignment stage 6 on the plate table 3 and provided on the substrate 9 held on the alignment stage 8 on the substrate table 4 while the plate 7 and the substrate 9 are arranged respectively at the predetermined positions of the alignment areas 15, 15a.

When, in the transfer mechanism portion 10, the blanket roller 11 is brought into contact with the plate 7 held on the plate table 3 or the substrate 9 held on the substrate table 4, the positional correction of the plate 7 and the substrate 9 by the alignment stages 6, 8 on the tables 3, 4 for addressing a decrease in the degree of straightness of the guide rails 2 and in the degree of orthogonality of the guide rails 2 with respect to the center of axle of the blanket roller 11, and the correction of the moving speeds of the plate 7 and the substrate 9 for addressing an off-centering of the blanket roller 11 may be made in a combined manner.

So long as the transfer mechanism portion 10 is capable of bringing the blanket roller 11 from above into contact with the plate 7 held on the plate table 3 and the substrate 9 held on the substrate table 4 that are traveling along the guide rails 2, any form of transfer mechanism portion 10 may be used.

So long as the inking apparatus 14 is capable of performing proper inking onto the plate 7 held on the plate table 3, any form of inking apparatus 14 may be used.

The offset printing method and apparatus of the present invention may be applied to the case where printing is performed onto a printing target other than the substrate 9.

Other than these, it is obvious that a variety of modifications can be made without departing from the spirit or scope of the present invention.

### INDUSTRIAL APPLICABILITY

As has been described above, according to the present invention, it is possible to provide an offset printing apparatus with an improved printing accuracy capable of printing fine printing pattern accurately and with high reproducibility.

### DESCRIPTION OF THE REFERENCE SYMBOLS

1: mount, 2: guide rail, 3: plate table, 4: printing target table, 6: alignment stage, 7: plate, 8: alignment stage, 9: substrate (printing target), 11: blanket roller, 15: alignment area, 16: alignment area, 18: precision camera (alignment sensor)

1. An offset printing apparatus that comprises a plate table and a printing target table separately or integrally traveling on a guide rail provided on a mount, and brings from above a blanket roller into contact with a plate held on the plate table and a printing target held on the printing target table in a sequential manner, to thereby perform a transfer from the plate to the blanket roller and a retransfer from the blanket roller to the printing target,
wherein the plate is held on an alignment stage provided on a top portion of the plate table, wherein the printing target is held on an alignment stage provided on a top portion of the printing target table, and wherein there are respectively provided at required locations on the mount an alignment area for aligning the plate held on the alignment stage on the plate table and an alignment area for aligning the printing target held on the alignment stage on the printing target table.

2. The offset printing apparatus according to claim 1,
wherein, instead of a structure in which the alignment areas for separately aligning the plate held on the alignment stage on the plate table and the printing target held on the alignment stage on the printing target table, there is provided at a required location on the mount a common alignment area for aligning the plate held on the alignment stage on the plate table and aligning the printing target held on the alignment stage on the printing target table, and wherein the alignment area comprises a common alignment sensor for detecting the plate held on the alignment stage on the plate table and the printing target held on the alignment stage on the printing target table.

3. The offset printing apparatus according to claim 1,
wherein it is possible to align the plate and the printing target even if the blanket roller is in contact with the plate or the printing target held respectively on the alignment stage on the plate table or the alignment stage on the printing target table.

4. The offset printing apparatus according to claim 2,
wherein it is possible to align the plate and the printing target even if the blanket roller is in contact with the plate or the printing target held respectively on the alignment stage on the plate table or the alignment stage on the printing target table.
